(19) United States
(12) Patent Application Publication
(10) Pub. No.: US 2006/0147167 A1
(43) Pub. Date: Jul. 6, 2006

(54) Advanced dispersion map for DSF transmission system

(75) Inventors: Gabriel Charlet, Villiers-Le-Bacle (FR); Jean-Christophe Antona, Montrouge (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/296,512

(22) Filed: Dec. 8, 2005

(30) Foreign Application Priority Data
Jan. 4, 2005 (EP) 05 290 012.3

(51) Int. Cl. G02B 6/02

(52) U.S. Cl. 385/123

(57) ABSTRACT

It is proposed a method for processing optical signals to be transmitted through a succession of transmission lines spans made out of DSF and a system architecture allowing the implementation of such a method for compensating dispersion occurring at the transmission path without suffering too much from any cross-phase modulation. This is achieved by the use of a system architecture comprising a succession of transmission lines spans made out of dispersion shifted fibers DSF with in-between a stage made alternately by a single mode fiber SMF or a dispersion compensating fiber DCF. Both DSF and SMF have dispersion of same sign. In another embodiment of the system architecture, the used DSF and SMF have also both dispersion slope of same sign. In such a way, it is possible to limit the impact of the XPM by not compensating the dispersion and possibly the dispersion slope at each span.

### TECHNICAL FIELD

The present invention relates to a method for processing optical signals to be transmitted through a succession of transmission lines spans. Furthermore, it is related to a system architecture for long haul transmission of optical signals. The invention is based on a priority application EP 05 290 012.3 which is hereby incorporated by reference.

### BACKGROUND OF THE INVENTION

Nonlinear optical effects such as four-wave mixing (FWM) and Cross-Phase Modulation (XPM) can degrade the optical signal transmission through long-haul optical networks. Increasing the dispersion in the fibers decreases both FWM and XPM. Indeed, accumulated dispersion itself causes broadening in transmitted optical pulses since it implies different group velocities for optical pulses at different wavelengths. In fact, the relative group velocity of pulses at different wavelengths will be high therefore diminishing the interaction time between such pulses with different wavelengths. A specific pulse will just see an averaged effect, the average power of other channels, that will result in a constant phase shift through XPM which implies no penalty at all. Dispersion units are typically given as picoseconds/nanometer·kilometer (ps/nm·km), where the kilometer units correspond to the length of the fiber. The dispersion product of a span of fiber is a measure of the dispersion accumulated over the span.

Some dispersion is even supported due to the requirement to reduce nonlinear effects such as FWM and XPM. But to keep the overall dispersion in tolerable limit, it is therefore necessary to compensate regularly the accumulated dispersion in these long-haul systems. In long-haul repeatered transmission systems using optical fibers, the interplay of the accumulation of large amounts of the chromatic dispersion and self-phase modulation (SPM), creates noise and distortion in the optical system. Indeed, conversely to FWM and XPM the non-linear effect SPM tends to increase with increasing dispersion. Dispersion maps, i.e. the dispersion as a function of the transmission distance, attempt to minimize the effects of chromatic dispersion.

Current submarine transmission systems generally have span lengths in the 45-50 km range and use a dispersion map which provides an average dispersion at a wavelength of 1560 nm of around −2 ps/nm-km in the approximately 90% of the transmission spans. The negative dispersion fibers used in those spans may be single fiber types or combinations of two fibers, in which case the fiber following the amplifier has a larger effective area to reduce nonlinear effects and the second fiber has a lower dispersion slope. The dispersion slope of a fiber is the change in the dispersion per unit wavelength. After approximately 10 spans, the accumulated negative dispersion is then compensated at a given wavelength by an additional span of single mode fiber (SMF).

The combination of spans of different kind of fibers is performed according to the elected dispersion map. In the literature can be found different kinds of strategy when defining a dispersion map. For example, in U.S. Pat. No. 6,317,238 is described a method and an apparatus optimized for dispersion mapping that yields improved transmission performance for optical transmission systems. In particular, the chromatic dispersion is arranged on both a short and a long length scale so that the average dispersion returns to zero. In U.S. Pat. No. 6,580,861 is described an optical transmission system including a series of consecutive blocks of optical fiber. Each block of the system includes a first, second and third series of spans of optical fiber, where the second series of the spans compensates for accumulated dispersion in the first and third series in the wavelength range of transmission. In such a system, the accumulated dispersion at a wavelength between the used channels is brought back to zero after each block.

In WO 02/056069 is described a method and apparatus for optimizing the dispersion and dispersion slope for a dispersion map with slope-compensating optical fibers. Such apparatus comprises an optical sub-link including operationally coupled optical fiber segments. The optical fiber segments are from a first optical fiber type, a second optical fiber type and a third optical fiber type. The first optical fiber type has a positive dispersion and a positive dispersion slope. The second optical fiber type has a negative dispersion and a negative dispersion slope. The third optical fiber type has one from the group of a positive dispersion and a negative dispersion slope, and a negative dispersion and a positive dispersion slope. In such a way it is expected to optimize the dispersion compensation without implying too high cross-phase modulation. But, beside the fact that it is not possible to have a conventional fiber with positive dispersion and negative dispersion slope, such solution is not so adequate for long-haul transmission system comprising low dispersion fiber such as dispersion shifted fibers DSF and first generation non-return to zero dispersion shifted fibers NZ-DSF.

### SUMMARY OF THE INVENTION

In view of the above, it is an object of the present invention to provide a method for processing optical signals to be transmitted through a succession of transmission lines spans made out of DSF and a system architecture allowing the implementation of such a method for compensating dispersion occurring at the transmission path without suffering too much from any cross-phase modulation or four-wave mixing.

This object is achieved in accordance with the invention by the use of a system architecture comprising a succession of transmission lines spans made out of dispersion shifted fibers DSF with at the interstage of an amplifier alternately single mode fiber SMF or Dispersion Compensating fiber DCF. Advantageously, the DCF is chosen such to compensate the dispersion and the dispersion slope of the previous SMF and the DSF. In such a way, it is possible to limit the impact of the XPM by not compensating the dispersion and possibly the dispersion slope at each span.

Advantageous developments of the invention are described in the dependent claims, the following description and the drawings.

### DESCRIPTION OF THE DRAWINGS

An exemplary embodiment of the invention will now be explained further with the reference to the attached drawings in which:

FIG. 1a, 1b show a system architecture and the corresponding chromatic dispersion in dependence on the distance as known from prior art;

FIG. 2a, 2b show a system architecture and the corresponding chromatic dispersion in dependence on the distance according to the present invention;

FIG. 3 shows a comparison of the penalty for the worst channel between the system architecture according to the prior art (squares) and according to the present invention (triangles).

### DETAILED DESCRIPTION OF PREFERRED EMBODIMENTS

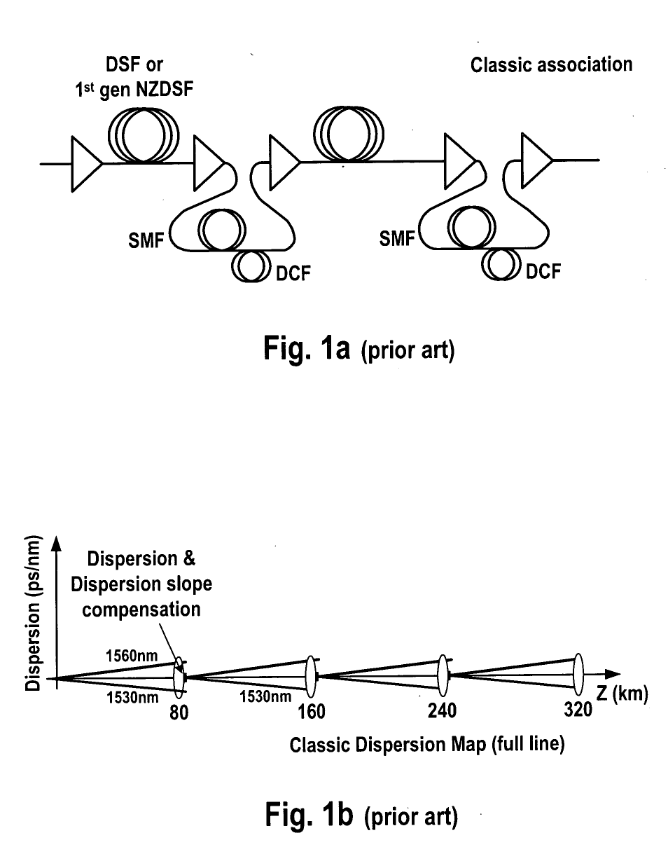

On FIG. 1a is shown a system architecture as known from the prior art. Between each fiber span made out of a dispersion shifted fiber DSF or first generation non-zero dispersion shifted fibers NZ-DSF is placed a stage made out of a single mode fiber SMF and a dispersion compensating fiber DCF. The different triangles depict the amplifiers. On FIG. 1b is shown the corresponding chromatic dispersion for such system architecture in dependence on the distance for optical signals at two different wavelengths, namely 1560 nm and 1530 nm. The used dispersion map is so that after each fiber span of DSF the chromatic dispersion is almost completely compensated. SMF is added in order to have the possibility to compensate the dispersion slope of DSF with the DCF.

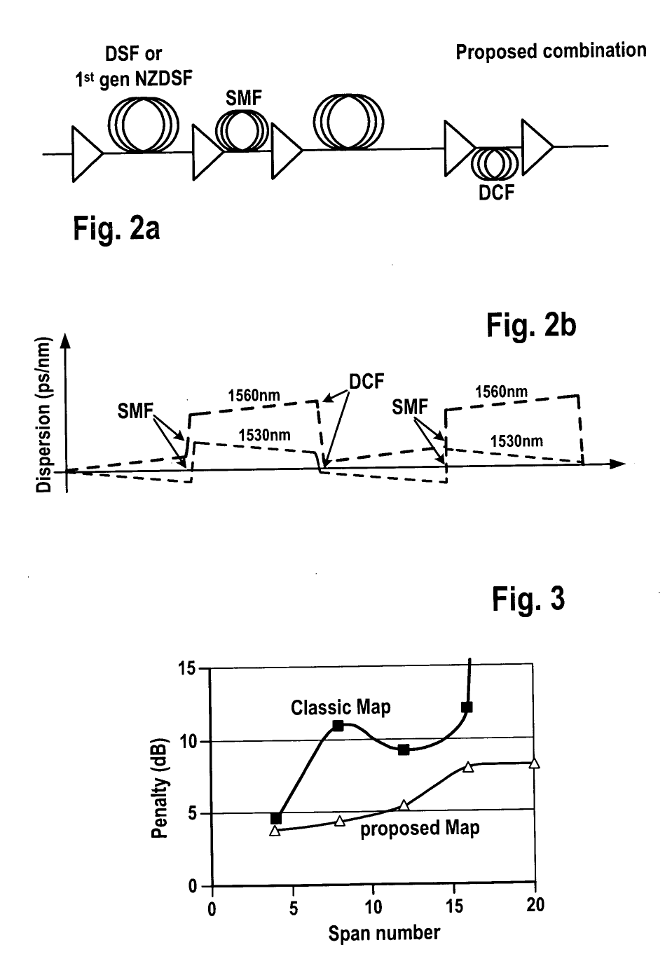

On FIG. 2a is shown a system architecture according to the invention. It is based on the choice not to compensate completely the dispersion and possibly also the dispersion slope after each span of DSF or first generation NZ-DSF. This is achieved with the architecture as shown on FIG. 2a with in-between each fiber span made out of a DSF or first generation NZ-DSF is placed alternating a SMF or a DCF. As on FIG. 1a, the triangles depict the usually used amplifiers. On FIG. 2b is shown the corresponding chromatic dispersion in dependence on the distance (km) for optical signals at two different wavelengths, namely at 1530 nm and 1560 nm. It is now obvious from such chromatic dispersion that the dispersion is not compensated after each span of DSF. This explains that for example for optical signals at wavelength 1560 nm the dispersion can reach quite high values before being compensated in the present case after two spans of DSF using a DCF. The chromatic dispersion property for optical signals at 1530 nm is a little bit different. But as for optical signals at wavelength 1560 nm the accumulated dispersion is also compensated only after two spans of DSF.

It is conceivable to dispatch the SMF and DCM over e.g. four spans or more (two spans with SMF spools and two spans with DCM).

In order to compensate 80 km of DSF, the association of 19 km of SMF and of a module designed to compensate 80 km of LEAF is required. In order to compensate 80 km of NZDSF (D=2 ps/nm.km-1 @1 550 nm and D′=0.07 ps/nm.km-2), 7 km of SMF and a Dispersion Compensating Module (DCM) designed to compensate 70 km of LEAF are required. The insertion loss of this association is compatible with the interstage of an EDFA (5 dB of insertion loss for the DCM module and less for the SMF). Instead of using the SMF spool and the DCM in the same amplifier, the proposition is to split them into 2 amplifiers as shown in FIG. 2b.

Numerical simulations have been launched to evaluate the transmission performance of N×10 Gbit/s WDM signal with 100 GHz spacing at a channel power of −5 dBm for both Dispersion Map. FIG. 3 depict the penalty (in dB) of the worst channel plot in function of the number of 80 km span of DSF of the transmission. It appears that the proposed dispersion Map gives always better result than the classical Map with dispersion compensation at each span.

In the case of a network with Optical Add-Drop Multiplexer, it can be more practical to have a residual dispersion near 0 at each node (even if it is a sub-optimal solution). A new constraint is added and the place of OADM has to be taken into account to keep the residual dispersion near 0 ps/nm at these points of the network. This can be done by using the “classic Map” for one span when a odd number of span separates two OADMs or by using larger amount of SMF in one interstage and lower amount DCF but for two spans.

1. A method for processing optical signals to be transmitted through a succession of transmission lines spans made out of dispersion shifted fibers DSF whereby forwarding the optical signals at the interstage of an amplifier alternately through a single mode fiber SMF or a dispersion compensating fiber DCF between each transmission line span while the DCF is chosen such to compensate the dispersion and the dispersion slope of the previous SMF and of the DSF.

2. A system architecture for long haul transmission of optical signals comprising a succession of transmission lines spans made out of dispersion shifted fibers DSF with in-between a stage made alternately by a single mode fiber SMF or a dispersion compensating fiber DCF while the DCF is chosen such to compensate the dispersion and the dispersion slope of the previous SMF and of the DSF.

3. The system architecture according to claim 2 wherein the transmission lines spans are first generation non-zero dispersion shifted fibers NZDSF.
